(19) United States
(12) Patent Application Publication
(10) Pub. No.: US 2006/0137201 A1
(43) Pub. Date: Jun. 29, 2006

(54) Laser goniometer for measuring the angle of a surface

(75) Inventors: Scott A. Dixon, Henderson, KY (US); Kim Burcham, Owensboro, KY (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/022,553

(22) Filed: Dec. 23, 2004

(51) Int. Cl. B23Q 17/22

(52) U.S. Cl. 33/628

(57) ABSTRACT

A goniometer for measuring an angle of a surface of an object is provided. The goniometer includes a frame with an engagement element configured for engaging the object. A laser generator is carried by the frame and is configured for emitting a laser beam onto the surface of the object when the object engages the engagement element. The goniometer further includes a scale carried by the frame. The laser beam is reflected from the object towards the scale and the scale is configured for indicating an angle of the surface of the object onto which the laser beam is directed when emitted by the laser generator. The object may be a creping blade and the goniometer may be used in order to measure the grind angle of the creping blade.

### BACKGROUND

The manufacture of paper products such as paper towels, facial tissue and bath tissue often involves forming a wet tissue web of papermaking fibers and then transferring the web to the surface of a rotating, heated drying drum sometimes referred to as a Yankee dryer. The web may adhere to the surface of the Yankee dryer due to the moisture content of the web, the smoothness of the surface of the Yankee dryer, and/or an adhesive that is sprayed onto the surface of the Yankee dryer. The web dries on the surface of the Yankee dryer and is removed therefrom by a creping blade that is typically pressed against the surface of the Yankee dryer. The energy transferred to the web upon contact with the creping blade acts to break a portion of the internal fiber-to-fiber bonds in the web so as to increase the softness of the resulting product.

The geometry of the creping blade has an impact on the attributes and quality of the resulting product. Referring to FIG. 1, one such geometric feature of the creping blade 12 that impacts the resulting product is the creping blade grind angle 14. As such, paper manufacturers desire an accurate measurement of the creping blade grind angle in order to ensure desired product qualities are achieved.

One type of conventional device used to measure the creping blade grind angle employs a sighting tube and a flashlight that are configured with a digital angle finder. The device is rotated around an axis of the creping blade until light is reflected into the sighting tube. The resulting angle is displayed on the digital angle finder. This type of device requires the operator to interpret the point at which light is reflected and therefore results in inaccuracy between testers. Additionally, this type of device is not suitable for measuring certain types of creping blades such as continuous creping blades.

### SUMMARY

Various features and advantages of the invention will be set forth in part in the following description, or may be obvious from the description, or may be learned from practice of the invention.

One exemplary embodiment provides for a goniometer for use in measuring an angle of a surface of an object. Although the goniometer may be used for the measurement of any object, the present application discusses a goniometer for measuring a grind angle on a creping blade for purposes of describing one or more exemplary embodiments. Again, it is to be understood that various exemplary embodiments exist in which the goniometer may be used for measuring an angle of a surface of an object other than a creping blade.

The goniometer includes, in one exemplary embodiment, a frame that has an engagement element configured for engaging the object. The goniometer also includes a laser generator carried by the frame and configured for emitting a laser beam onto the surface of the object when the object engages the engagement element. A scale is also included and is carried by the frame. The laser beam is reflected from the object towards the scale and the scale is configured for indicating an angle of the surface of the object onto which the laser beam is directed when emitted by the laser generator.

As stated, the goniometer is capable of measuring the grind angle of a creping blade in accordance with various exemplary embodiments. Here, the frame defines a creping blade engagement surface that is configured for engaging the creping blade. A laser generator is included and is carried by the frame and configured for emitting a laser beam onto the tip of the creping blade when the creping blade engages the creping blade engagement surface. A scale is also provided that is carried by the frame and is disposed relative to the path of the laser beam after reflection of the laser beam from the tip of the creping blade. The scale is capable of indicating the grind angle of the creping blade from the reflected laser beam.

Also provided for in accordance with another exemplary embodiment is a goniometer as discussed above where the laser beam is reflected directly from the object onto the scale in order to indicate the angle of the surface of the object onto which the laser beam is directed when emitted.

Also provided in another exemplary embodiment is a goniometer as previously discussed where the frame includes an L-bracket that defines the engagement element on one leg.

Another exemplary embodiment exists in a goniometer as discussed above where the frame includes a fin. Both the laser generator and scale are carried by the fin.

Another exemplary embodiment resides in a goniometer as previously discussed where the frame defines an aperture. The laser generator is configured to emit the laser beam through the aperture and onto the surface of the object so that the laser beam is then reflected from the surface of the object back through the aperture and towards the scale.

Also provided in accordance with yet another exemplary embodiment is a goniometer as previously discussed in which the scale is arcuate shaped. The scale has a range of marks capable of indicating the angle of the surface of the object that may be between 5 and 30°.

In an exemplary embodiment for measuring a grind angle on a creping blade, the goniometer includes a frame that has an L-bracket and a fin. A leg of the L-bracket defines a creping blade engagement surface that is configured for engaging the creping blade. A laser generator is provided and is attached to the fin. The laser generator is configured for emitting a laser beam onto the tip of the creping blade when the creping blade engages the creping blade engagement surface. An arcuate shaped scale is attached to the fin. The scale is configured for receiving the laser beam after reflection of the laser beam from the tip of the creping blade. The scale is configured for indicating the grind angle of the creping blade. Additionally, a handle is provided and attached to the frame.

These and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a partial side view of a creping blade with a tip that is angled.

FIG. 2 is a perspective view of an exemplary embodiment of a goniometer.

The goniometer is in an operational mode in which a laser beam is reflected off of a creping blade and onto a scale so as to indicate the grind angle of the tip of the creping blade.

FIG. 3 is a side view of the goniometer of FIG. 2 also shown engaged with a creping blade.

FIG. 4 is a front view of the goniometer of FIG. 2. The creping blade is not present.

FIG. 5 is a front view of the goniometer in accordance with another exemplary embodiment. The goniometer is in an operational mode in which a laser beam is reflected off a creping blade so as to reflect adjacent to a scale in order to indicate the grind angle of the creping blade.

FIG. 6 is a side view of a goniometer in accordance with another exemplary embodiment. An engagement element engages an object and a laser beam is reflected off of a surface of the object and onto a scale so as to indicate the angle of the surface.

Repeat use of reference characters in the present specification and drawings is intended to present same or analogous features or elements of the invention.

### DETAILED DESCRIPTION OF REPRESENTATIVE EMBODIMENTS

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

It is to be understood that the ranges and limits mentioned herein include all ranges located within, and also all values located under or above the prescribed limits. It is to be also understood that all ranges mentioned herein include all subranges included in the mentioned ranges. For instance, a range from 100-200 also includes ranges from 110-150, 170-190, and 153-162. Further, all limits mentioned herein include all other limits included in the mentioned limits. For example, a limit of up to about 7 also includes a limit of up to about 5, up to about 3, and up to about 4.5.

In accordance with one exemplary embodiment, a goniometer 10 is provided that is capable of measuring a grind angle 14 of a creping blade 12. Although described as measuring the grind angle 14 of a creping blade 12, it is to be understood that the goniometer 10 as described herein is capable of measuring other types of objects besides a creping blade 12. Description with respect to a creping blade 12 is provided solely for purposes of illustration of certain exemplary embodiments.

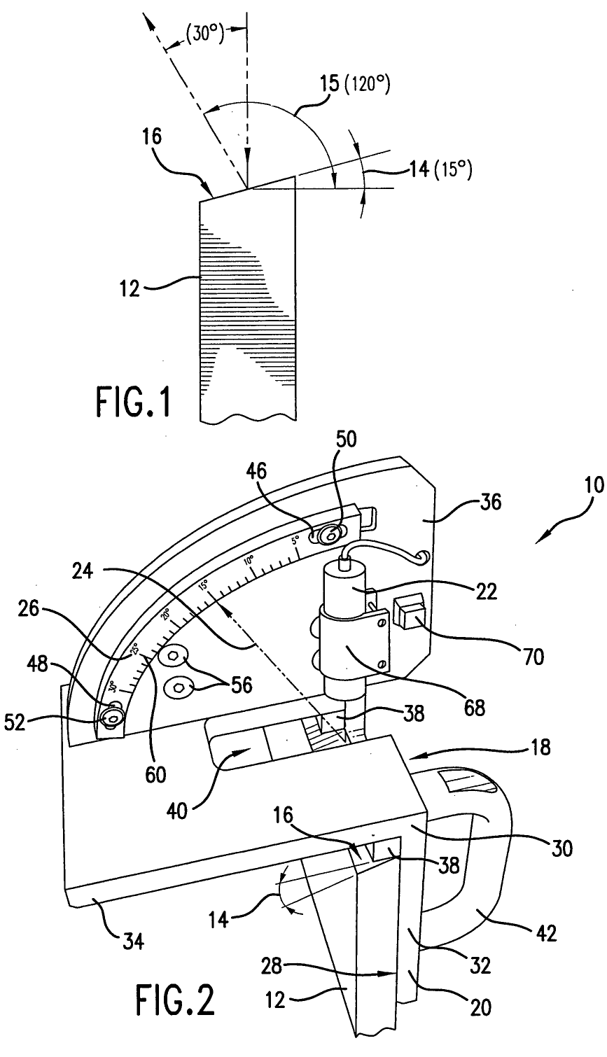

A creping blade 12 is shown in side view in FIG. 1 that includes a tip 16 angled with respect to the sides of the creping blade 12. The grind angle 14 of the creping blade 12 in FIG. 1 is 15°. It is sometime the case that different manufacturers or suppliers of creping blades 12 will refer to the grind angle as being an angle different from the angle labeled as reference character 14. For example, various manufacturers or suppliers sometimes refer to angle 15 as the grind angle. As such, the grind angle of a particular creping blade 12 is assigned different values depending upon the manufacturer or the supplier. It is to be understood that the term “grind angle” as used herein refers to the angle of a surface of the creping blade 12. The term “grind angle” is not limited to an angle measured by a particular manufacturer or supplier but is broad enough to cover an angle of the creping blade 12 that is measured and referred to by any manufacturer or supplier of creping blades. The goniometer 10 is capable of measuring any type of creping blade 12. A known creping blade is disclosed in U.S. Pat. No. 5,753,076 issued to Costello et al., the entire contents of which are incorporated herein by reference in their entirety for all purposes.

An exemplary embodiment of a goniometer 10 is shown in FIG. 2. Here, the goniometer 12 includes a frame 18 that is at least partially made of an L-bracket 30. A creping blade engagement surface 28 is defined on one leg 32 of the L-bracket 30. The creping blade engagement surface 28 is configured for engagement with the creping blade 12. Fin 36 is attached to leg 34 of the L-bracket 30. A laser generator 22 is attached to the fin 36 by way of mounting 68. The laser generator 22 is activated by a switch 70 that is also attached to the fin 36.

Fin 36 also carries a scale 26. As shown, the scale 26 is arcuate shaped and is adjustably attached onto the fin 26 so that the relative position of the scale 26 and fin 36 may be adjusted. In this regard, a bolt 50 is disposed through a slot 46 in the fin 36. Likewise, a bolt 52 is disposed through slot 48 in fin 36. Slots 46 and 48 allow for adjustment of the positioning of scale 26 on fin 36. It is to be understood, however, that in accordance with other exemplary embodiments the scale 26 is configured on fin 36 so as to be non-adjustable. Additionally, other mechanisms may be employed so as to attach scale 26 to fin 36 in an adjustable or non-adjustable fashion as is commonly known to one having ordinary skill in the art. Scale 26 is integral with fin 36 so that these two components are essentially one piece in accordance with other exemplary embodiments.

Scale 26 is provided with a series of marks 60 that may be used to indicate the grind angle 14 of the creping blade 12. In operation, the switch 70 is pressed by a user so as to cause the laser generator 22 to emit a laser beam 24 that contacts the tip 16 of the creping blade 12. The laser beam 24 is then reflected off of the tip 16 towards the scale 26. The grind angle 14 of the creping blade 12 is then measured by noting the mark 60 contacted by the laser beam 24.

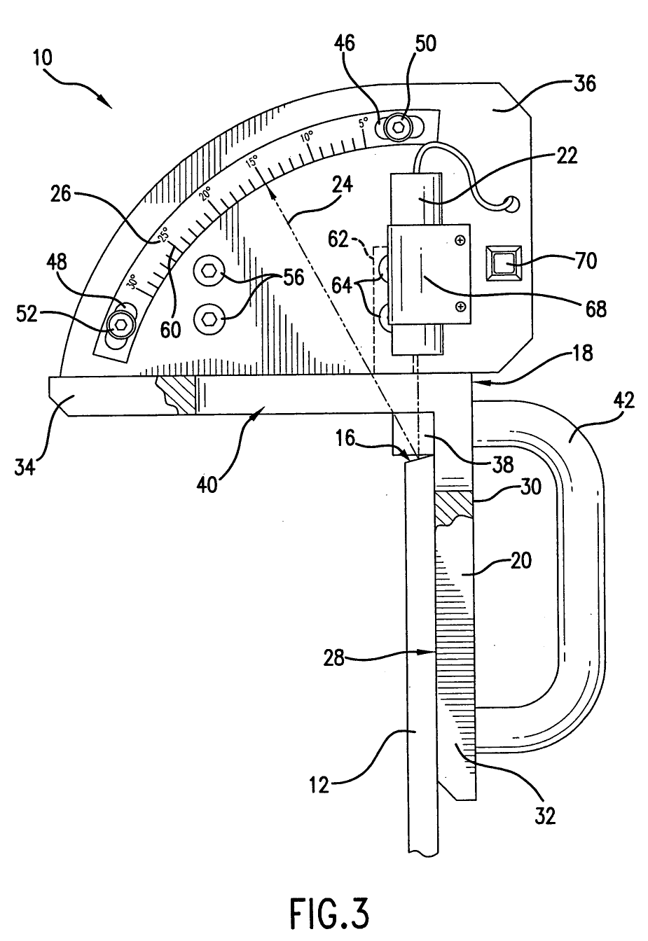

FIG. 3 shows a side view of the goniometer 10 of FIG. 2. The scale 26 is shown having marks 60 used to indicate a range of 5° to 30°. The angle of incidence of the laser beam 24 is equal to the angle of reflection of the laser beam 24 from the tip 16 of the creping blade 12. The angle of the laser beam 24 does not change in relationship to the creping blade 12. As such, a 1° change in the grind angle 14 will produce a 2° change in the reflection of the laser beam 24 from the tip 16. As such, the marks 60 on scale 26 are spaced accordingly so as to be 2° apart from one another in order to measure only a single degree of difference in the grind angle 14. Therefore, each mark 60 on the scale 26 represents a 1° change in the grind angle 14 of the creping blade 12.

Although the scale 26 of this exemplary embodiment is shown as being capable of measuring 1° differences in the grind angle 14 through a range from 5° to 30° of the grind angle 14, it is to be understood that the scale 26 can be variously configured in accordance with other exemplary embodiments. For instance, the marks 60 may be arranged so as to be capable of measuring differences in grind angles 14 that are 0.25°, 0.5°, and/or 0.75° from one another. Additionally or alternatively, the range of the scale 26 is different in accordance with other exemplary embodiments so as to be capable of measuring any degree of grind angle 14 deviation. For example, the range of the scale 26 is from 10° to 20°, 0° to 45°, 0° to 90°, or 0° to 360° in accordance with various exemplary embodiments. Further, it is to be understood that the marks 60 on scale 26 may be labeled in different fashions in accordance with different schemes used by manufacturers and suppliers to measure the grind angle 14. As such, the scale 26 may be used to indicate a grind angle 14 of a negative value in accordance with one exemplary embodiment.

A blade stop 38 may be attached to the frame 18. The creping blade 12 engages the creping blade engagement surface 28 and the tip 16 is placed into engagement with the blade stop 38 so as to properly position the creping blade 12 with respect to the goniometer 10. The blade stop 38 is made out of any suitable material. For instance, in one exemplary embodiment the blade stop 38 is made from steel.

As shown in FIGS. 2 and 3, an aperture 40 is defined in the frame 18 so as to allow the laser beam 24 to be directed through the frame onto the tip 16 of the creping blade 12. The aperture 40 also allows the laser beam 24 to be directed back through the frame and towards the scale 26.

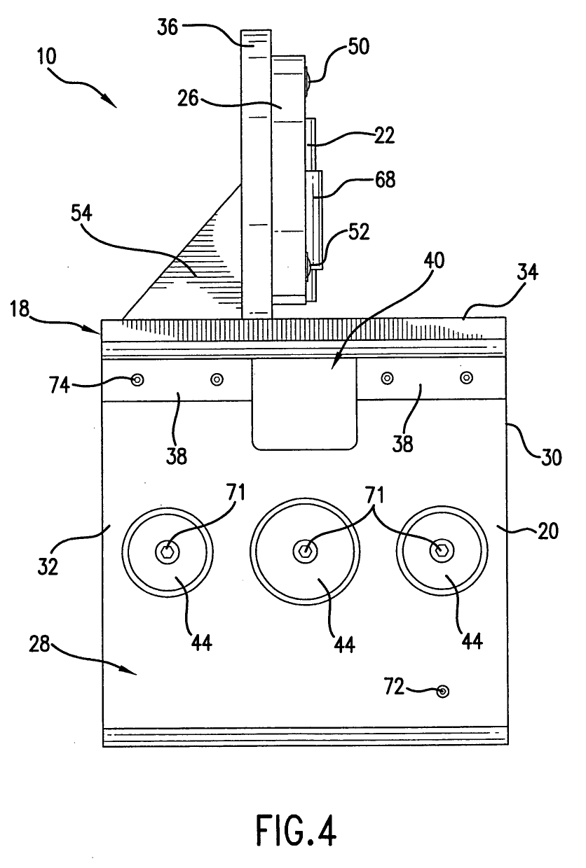

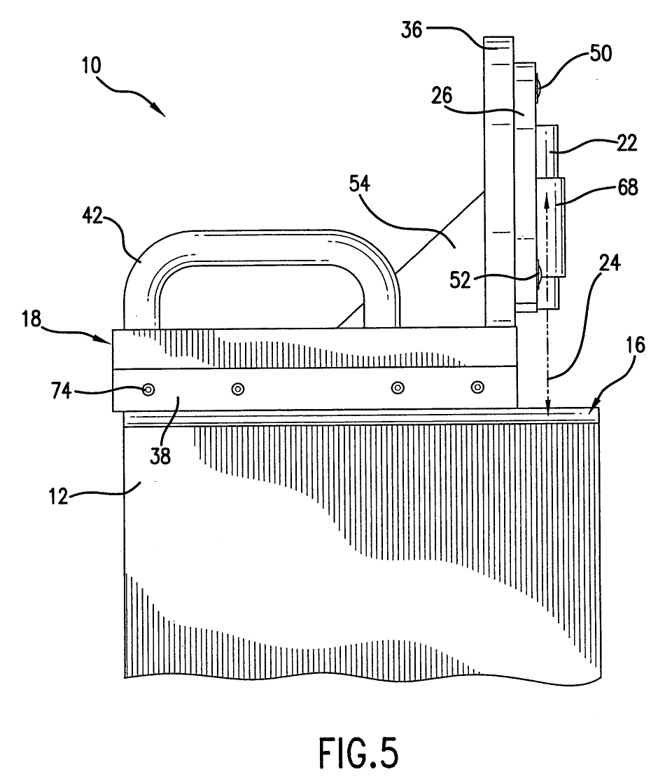

A handle 42 may be provided and is attached to the frame 18 through bolts 72 (FIG. 4). Handle 42 allows for one to easily maneuver the goniometer 10 into contact with various objects such as the creping blade 12. FIG. 4 shows a series of magnets attached to the frame 18 by bolts 71. Magnets 44 are used to urge engagement between the creping blade 12 (FIG. 3) and the creping blade engagement surface 28. The magnets 44 are provided in any number or are made with any strength in order to achieve a desired engagement between the creping blade 12 and the creping blade engagement surface 28. It is to be understood, however, that in other exemplary embodiments the magnets 44 need not be present.

FIG. 4 also shows the attachment between the blade stop 38 and the frame 18 as being effected through a series of bolts 74. Although shown attached with bolts 74, the blade stop 38 can be attached in other manners in other exemplary embodiments. Welding, adhesion or clips could be used to attach the blade stop 38 and frame 18. Alternatively, blade stop 38 may be made integral with frame 18 so that these two components are essentially one piece. As shown in FIG. 4, the blade stop 38 is made of a pair of inserts. It is to be understood that in other exemplary embodiments that the blade stop 38 is made from a single piece or need not even be present.

A support rib 54 may also be used in one exemplary embodiment in order to help support the fin 36. The support rib 54 is attached to the leg 34 of the L-bracket 30 and to the fin 36 in order to provide the aforementioned support. The support rib 54 is attached to these two components in any manner. Referring back to FIG. 3, a pair of bolts 56 are provided in order to attach the support rib 54 to the fin 36. Likewise, one or more bolts (not shown) are used in order to effect attachment between the support rib 54 and the leg 34. Additionally, other manners of attachment are employed in order to connect these two components such as welding, adhesion or clips. Further, the support rib 54 may be an integral component with the leg 34 and the fin 36 in that these components may be cast as a single piece. A second support rib 62 may also be provided in order to further support the fin 36. The support rib 62 is attached to the fin 36 by a series of bolts 64 and to the leg 34 by one or more bolts (not shown). Additionally, the support rib 62 is attached to the fin 36 and the leg 34 in any manner as previously discussed with respect to the support rib 54. The support ribs 54 and 62 act to help keep the fin 36 steady during operation of the goniometer 10.

The goniometer 10 can be calibrated by using a creping blade 12 with a known grind angle 14. Here, the creping blade engagement surface 28 is placed into engagement with the creping blade 12 so that the tip 16 of the creping blade 12 contacts the blade stop 38. Next, the laser generator 22 is activated and the position of the laser beam 24 of the scale 26 is noted. The bolts 50 and 52 are loosened and the position of the scale 26 with respect to the fin 36 is adjusted so as to align the laser beam 24 with the correct mark 60 on the scale 26 in order to correspond to the known grind angle 14. The bolts 50 and 52 are then tightened so as to properly position the scale 26 on the fin 36 in order to ensure proper calibration.

The goniometer 10 is made of any suitable material. For instance, in one exemplary embodiment the frame 18, scale 26, fin 36 and handle 42 are all made from aluminum. Alternatively, the frame 18 and fin 36 is aluminum while the scale 26 and handle 42 are made from steel in accordance with another exemplary embodiment. Additionally, the goniometer 10 is manufactured through any suitable process. For instance, the frame 18, the scale 26, fin 36 and handle 42 along with support ribs 54 and 62 may be machined. Additionally or alternatively, casting can be employed in order to create one or more of the components of the goniometer 10.

In accordance with one exemplary embodiment, the tip 16 of the creping blade 12 is located 3.875″ from the scale 26. In accordance with other exemplary embodiments, the positioning of the laser generator 22, scale 26, and creping blade 12 is variously positioned. For instance, the distance between the tip 16 of the creping blade 12 is 2″, 10″, up to 15″ or up to 20″ away from the scale 26. Further, the distance between the laser generator 22 and the tip 16 is 2″, 3″ up to 5″ or up to 10″ in accordance with other exemplary embodiments.

FIG. 5 shows an alternative exemplary embodiment of the goniometer 10. Here, the aperture 40 of the exemplary embodiment shown in FIG. 2 is not present. Instead, the fin 36 is positioned on the edge of the frame 18. Additionally, the frame 18 does not include an L-bracket 30 as discussed in previous exemplary embodiments but does have a blade stop 38 used for engaging the creping blade 12. The laser generator 22 is positioned on the fin 36 so as to extend past the frame 18. The laser generator 22 emits a laser beam 24 that contacts the tip 16 of the creping blade 12 so as to measure the grind angle 14 of the creping blade 12. After reflection from the tip 16, the laser beam 24 shines next to the scale 26 but does not contact the scale 26. The user ascertains the correct angular measurement upon lining up the reflected laser beam 24 and the mark 60 on the scale 26 past which the laser beam 24 is directed. As such, the goniometer 10 is variously configured in accordance with other exemplary embodiments.

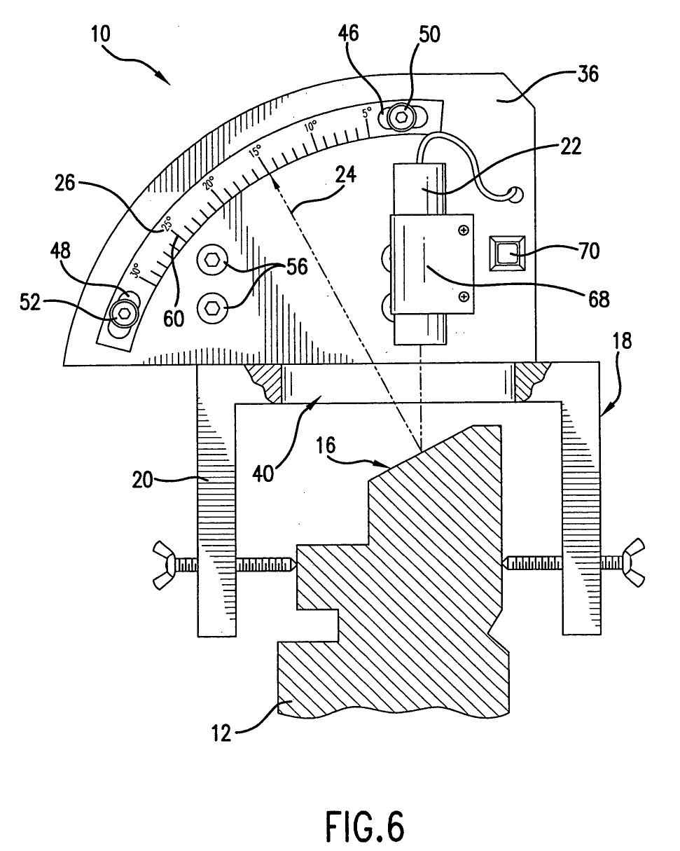

FIG. 6 shows another exemplary embodiment of the goniometer 10. Here, the goniometer 10 is used for measuring an object 12 that is not a creping blade. The goniometer 10 is provided with a laser generator 22 that emits a laser beam 24 onto a surface 16 of the object 12. The laser beam 24 is reflected therefrom onto a scale 26 that includes marks 60 to allow the user to determine the angle 14 of the surface 16. In this exemplary embodiment, the goniometer 10 engages the object 12 through an engagement element 20 that includes a pair of set screws. Although the engagement element 20 was described in previous exemplary embodiments as being a surface 28, it is to be understood that the engagement element 20 is variously configured in accordance with other exemplary embodiments. For instance, the engagement element 20 can be one or more set screws, magnets, clips, clamps or bolts in other exemplary embodiments. The engagement element 20 may be simply a surface that provides engagement between the goniometer 10 and the object 12. Additionally or alternatively, the engagement element 20 is a component used to effect a secure attachment between the frame 18 and the object 12 in accordance with other exemplary embodiments.

During manufacturing of the creping blade 12, a grinding process is typically employed in order to define the shape of the tip 16. The grinding process produces small scratches on the tip 16 that effect the reflection of the laser beam 24 from the tip 16. For instance, the angle of the scratches on the tip 16 impact the outer portion of the reflection of the laser beam 24 on the scale 26. The reflected laser beam 24 is flattened if a number of scratches on the tip 16 are present and is typically circular in cross-sectional shape if the tip 16 is essentially free of the scratches. The user of the goniometer 10 can disregard this additional information or use it in order to track changes in the grinding process of the creping blade so as to be aware of the amount of grinding to which the creping blade was subjected.

Any suitable laser generator 22 can be employed in accordance with various exemplary embodiments. For example, in accordance with one exemplary embodiment the laser generator 22 is a laser diode with a wavelength of 630-680 nm with a maximum output of <5 mW. This laser diode is a class IIIA laser that is manufactured by Alpec-team, Inc. whose address is 201 Rickenbacker Circle, Livermore, Calif. 94550.

Referring generally back to FIG. 2, the goniometer 10 can be used in a manufacturing environment so as to check various angles 14 on objects 12 such as a creping blade. Further, the goniometer 10 could also be used in a laboratory or at home for measuring angles. The goniometer 10 can be used in any conceivable location for any conceivable angular measurement. The laser generator 22 produces a laser beam 24 that provides a clear indication on the scale 26 of the measured angle 14 with no interpretation required by the user. The goniometer 10 provides accurate measurements with minimal operator training.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

What is claimed is:

1. A goniometer for measuring a grind angle on a creping blade, comprising:
a frame defining a creping blade engagement surface configured for engaging the creping blade;
a laser generator carried by said frame and configured for emitting a laser beam onto the tip of the creping blade when the creping blade engages said creping blade engagement surface; and
a scale carried by said frame, wherein said scale is disposed relative to the path of the laser beam after reflection of the laser beam from the tip of the creping blade, and wherein said scale is configured for indicating the grind angle of the creping blade from the reflected laser beam.

2. The goniometer as set forth in claim 1, wherein said frame includes an L-bracket and wherein said creping blade engagement surface is defined on a leg of said L-bracket.

3. The goniometer as set forth in claim 1, wherein said frame includes a fin and wherein said laser generator and said scale are carried by said fin.

4. The goniometer as set forth in claim 1, further comprising a blade stop carried by said frame, and wherein said blade stop is configured for engagement with the tip of the creping blade.

5. The goniometer as set forth in claim 1, wherein said frame defines an aperture and wherein said laser generator is configured to emit the laser beam through the aperture and onto the tip of the creping blade such that the laser beam is reflected from the tip of the creping blade back through the aperture and towards said scale.

6. The goniometer as set forth in claim 1, further comprising a handle carried by said frame.

7. The goniometer as set forth in claim 1, further comprising a magnet carried by said frame and configured for urging engagement of said creping blade engagement surface to the creping blade.

8. The goniometer as set forth in claim 1, wherein said scale is adjustable such that the relative positioning of said frame and said scale is capable of being modified.

9. The goniometer as set forth in claim 1, wherein said scale is arcuate shaped and has a range of marks capable of indicating a grind angle from between five and thirty degrees.

10. A goniometer for measuring an angle of a surface of an object, comprising:
a frame having an engagement element configured for engaging the object;
a laser generator carried by said frame and configured for emitting a laser beam onto the surface of the object when the object engages said engagement element; and
a scale carried by said frame, wherein the laser beam is reflected from the object towards said scale, and wherein said scale is configured for indicating an angle of the surface of the object onto which the laser beam is directed when emitted by said laser generator.

11. The goniometer as set forth in claim 10, wherein said engagement element is a surface.

12. The goniometer as set forth in claim 10, wherein the laser beam is reflected directly from the object onto said scale in order to indicate the angle of the surface of the object onto which the laser beam is directed when emitted by said laser generator.

13. The goniometer as set forth in claim 10, wherein said frame includes an L-bracket and wherein said engagement element is defined on a leg of said L-bracket.

14. The goniometer as set forth in claim 10, wherein said frame includes a fin and wherein said laser generator and said scale are carried by said fin.

15. The goniometer as set forth in claim 10, further comprising a stop carried by said frame, and wherein said stop is configured for engagement with the object.

16. The goniometer as set forth in claim 10, wherein said frame defines an aperture and wherein said laser generator is configured to emit the laser beam through the aperture and onto the surface of the object such that the laser beam is reflected from the surface of the object back through the aperture and towards said scale.

17. The goniometer as set forth in claim 10, further comprising a handle carried by said frame.

18. The goniometer as set forth in claim 10, further comprising a magnet carried by said frame and configured for urging engagement of said engagement element and the object.

19. The goniometer as set forth in claim 10, wherein said scale is adjustable such that the relative positioning of said frame and said scale is capable of being modified.

20. The goniometer as set forth in claim 10, wherein said scale is arcuate shaped and has a range of marks capable of indicating the angle of the surface of the object from between five and thirty degrees.

21. A goniometer for measuring a grind angle on a creping blade, comprising:
a frame having an L-bracket and a fin, a leg of said L-bracket defining a creping blade engagement surface configured for engaging the creping blade;
a laser generator attached to said fin and configured for emitting a laser beam onto the tip of the creping blade when the creping blade engages said creping blade engagement surface;
an arcuate shaped scale attached to said fin, wherein said scale is configured for receiving the laser beam after reflection of the laser beam from the tip of the creping blade, and wherein said scale is configured for indicating the grind angle of the creping blade; and
a handle attached to said frame.
